(19) United States
(12) Patent Application Publication
(10) Pub. No.: US 2009/0100333 A1
(43) Pub. Date: Apr. 16, 2009

(54) VISUALIZING CIRCULAR GRAPHIC OBJECTS

(76) Inventor: Jun Xiao, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/873,408

(22) Filed: Oct. 16, 2007

(51) Int. Cl. G06F 17/50

(52) U.S. Cl. 715/252; 715/243; 715/247

(57) ABSTRACT

At least two circular graphic objects selected from a set of circular graphic objects are arranged at respective locations in a coordinate plane where the circular graphic objects are mutually tangent. Another one of the circular graphic objects is chosen from the set as a current circular graphic object. A current target one of the circular graphic objects in the coordinate plane is selected based on application of a selection metric to distances respectively separating the circular graphic objects in the coordinate plane from a reference location. The current circular graphic object is positioned at a respective location in the coordinate plane where the current circular graphic object is tangent to the current target circular graphic object and tangent to another one of the circular graphic objects in the coordinate plane. The choosing, the selecting, and the positioning are repeated.

### BACKGROUND

Digital cameras and mobile phone cameras have become increasingly ubiquitous and the cost for people to take and store the photos has decreased rapidly over time. As a result, the sizes of personal digital photo collections are growing exponentially. Many commercial applications and services try to better support users in searching and organizing photo collections. The main challenge for image search and organization is how to make related user tasks easy and intuitive and the experience enjoyable and intriguing.

### SUMMARY

In one aspect, the invention features a method in accordance with which at least two circular graphic objects selected from a set of circular graphic objects are arranged at respective locations in a coordinate plane where the circular graphic objects are mutually tangent. The coordinate plane has a reference location. Another one of the circular graphic objects is chosen from the set as a current circular graphic object. A current target one of the circular graphic objects in the coordinate plane is selected based on application of a selection metric to distances respectively separating the circular graphic objects in the coordinate plane from the reference location. The current circular graphic object is positioned at a respective location in the coordinate plane where the current circular graphic object is tangent to the current target circular graphic object and tangent to another one of the circular graphic objects in the coordinate plane. The choosing, the selecting, and the positioning are repeated. A specification of the locations of the circular graphic objects in the coordinate plane is generated.

Other features and advantages of the invention will become apparent from the following description, including the drawings and the claims.

### DESCRIPTION OF DRAWINGS

FIG. 1 is a block diagram of an embodiment of a visualization system.

FIG. 2 is a flow diagram of an embodiment of a visualization method.

FIG. 3 is a diagrammatic view of a coordinate plane and a reference location in the coordinate plane.

FIGS. 4A-4D are diagrammatic views of circular graphic objects positioned in the coordinate plane of FIG. 3 in accordance with the method of FIG. 2.

FIGS. 5A-5D are diagrammatic views of boundary lists that contain linked lists of peripheral ones of the circular graphic objects that have been positioned in the coordinate plane as shown in FIGS. 4A-4D, respectively.

FIG. 6 is a diagrammatic view of an exemplary layout of circular graphic objects that is generated in accordance with the method of FIG. 2.

FIG. 7 is a diagrammatic view of an exemplary layout of circular graphic objects that is generated in accordance with the method of FIG. 2.

FIG. 8 is a flow diagram of an embodiment of a method of modifying a layout of circular graphic objects on a page.

FIG. 9 is a diagrammatic view of an exemplary layout of circular graphic objects that is generated in accordance with the method of FIG. 2 and enclosed with an initial boundary perimeter.

FIG. 10 is a diagrammatic view of the exemplary layout of circular graphic objects shown in FIG. 9 and a final boundary perimeter that is determined in accordance with an embodiment of the method of FIG. 8.

FIG. 11 is a diagrammatic view of an exemplary layout of circular graphic objects that is generated in accordance with an embodiment of the method of FIG. 8 based on the boundary perimeter shown in FIG. 10.

FIG. 12 is a diagrammatic view of a devised population of data objects mapped into a metadata parameter space.

FIG. 13 is a diagrammatic view of a tree structure representing a hierarchy of data object clusters.

FIG. 14 is a block diagram of an embodiment of the visualization system of FIG. 1.

FIG. 15 is a diagrammatic view of a display presenting a graphical user interface containing a layout of circular face images representing respective face clusters.

FIG. 16 is a diagrammatic view of a graphical user interface for visualizing face clusters.

FIG. 17 is a block diagram of an embodiment of an apparatus incorporating an embodiment of the visualization system of FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Introduction

The embodiments that are described in detail herein provide ways to arrange circular graphic objects on a page. These embodiments not only provide visually appealing results that make efficient use of the available display area, but also achieve these results quickly and efficiently. Some embodiments additionally provide ways to utilize these arrangements of circular graphic objects in visualizing clustered data.

As used herein, the term “page” refers to any type of discrete area in which graphic objects may be laid out, including a physical page that is embodied by a discrete physical medium (e.g., a piece of paper) on which a layout of graphic objects may be printed, and a virtual, digital or electronic page that contains a layout of graphic objects that may be presented to a user by, for example, an electronic display device.

The term “graphic object” refers broadly to any type of visually perceptible content (including, but not limited to, images and text) that may be rendered in an area on a physical or virtual page. Image-based graphic objects (or simply “images”) may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image. The term “graphic object” encompasses both a single-element graphic object and a multi-element graphic object formed from a cohesive group or collection of one or more graphic objects. In general, the type of single-element graphic objects in a multi-element graphic object may be the same or different. The graphic objects that are described herein typically are stored in one or more databases on one or more computer-readable media.

### II. Visualizing Circular Graphic Objects

A. Overview

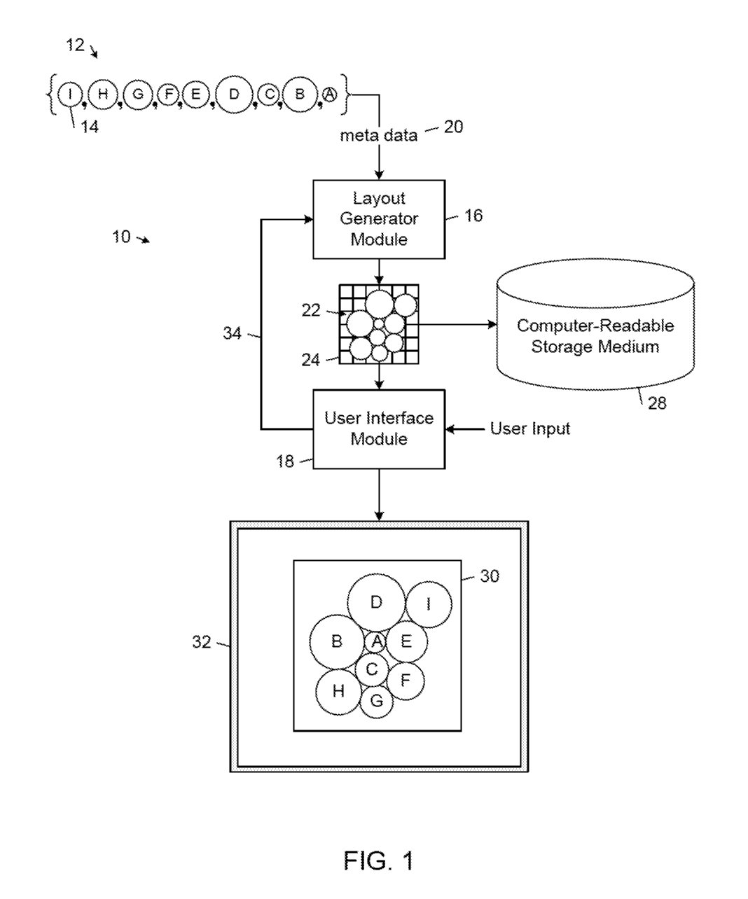

FIG. 1 shows an embodiment of a visualization system 10 for arranging a set 12 of circular graphic objects 14 on a page. The system 10 includes a layout generator module 16 and a user interface module 18 through which a user interacts with the graphic object arrangement system 10. The modules of the graphic object arrangement system 10 are not limited to any specific hardware or software configuration, but rather they may be implemented in any computing or processing environment, including in digital electronic circuitry or in computer hardware, firmware, device driver, or software. The circular graphic objects 14 typically are stored one or more local or remote image databases.

In operation, the layout generator module 16 receives metadata 20 that characterizes the circular graphic objects 14. The metadata typically is stored in one or more data structures that are arranged in, for example, an XML (eXtensible Markup Language) format. In some embodiments, the metadata 20 for each of the circular graphic objects 14 includes a respective size value (e.g., a radius value, a diameter value, an area value, a circumference value, or other value indicative of size) that indicates the size of the circular graphic object.

Based on the received metadata 20, the layout generator module 16 determines a layout of the circular graphic objects in a coordinate plane 24. As used herein, the term “coordinate plane” refers to a plane that contains points whose positions in the plane are uniquely determined by respective coordinates that are defined with respect to a coordinate system (e.g., a rectangular coordinate system, such as the Cartesian coordinate system). In some embodiments, the points in the coordinate plane correspond to pixel locations on a page.

In some implementations, the layout generator module 16 outputs a layout specification 22 that describes the positions of the graphic objects 14 in the coordinate plane 24. The layout specification 22 typically specifies the positions of the graphic objects 14 in terms of the coordinates of the centers of the circular graphic objects in a coordinate system that is defined with reference to a particular location (e.g., a corner point, an edge point, or center point) in the coordinate plane. In some embodiments, the layout generator module 16 outputs the circular graphic object layout 22 in the form of a layout specification that is arranged in a particular file format (e.g., PDF or XML) and is stored on a computer-readable storage medium 28.

The layout generator module 16 outputs the layout specification 22 to the user interface module 18. The user interface module 18 maps the circular graphic objects 14 onto a page 30 based on the layout specification 22 and presents (or renders) the page 30 on a display 32. In implementations in which the circular graphic objects 14 are linked to respective graphic object clusters (e.g., clusters of digital photographs), the user interface module 18 allows a user to browse the clusters by inputting commands that select one or more of the graphic objects on the display 32. The commands typically are input using, for example, an input device (e.g., a computer mouse, keyboard, touch pad, and the like). The user interface module 18 transmits the interpreted user commands to the layout generator module 16. The layout generator module 16 may determine a new layout of a different set of graphic objects in accordance with the interpreted commands received from the user interface module 18. The user interface module 18 presents another page to the user in accordance with the new page layout. The user may continue to browse the graphic objects, specify edits to the graphic objects or to the graphic object clusters, or command the system 10 to render some or all of the page layouts.

B. Generating a Space-Filling Layout of Circular Graphic Objects

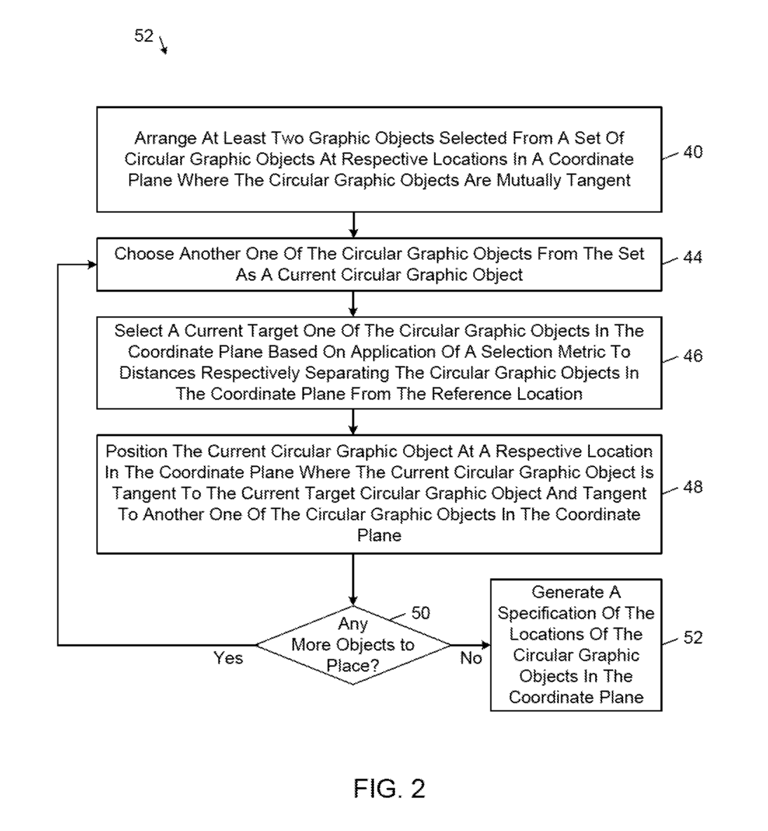

FIG. 2 shows an embodiment of a method by which the layout generator module 16 generates a layout for the set 14 of the circular graphic objects 14 in the coordinate plane 24.

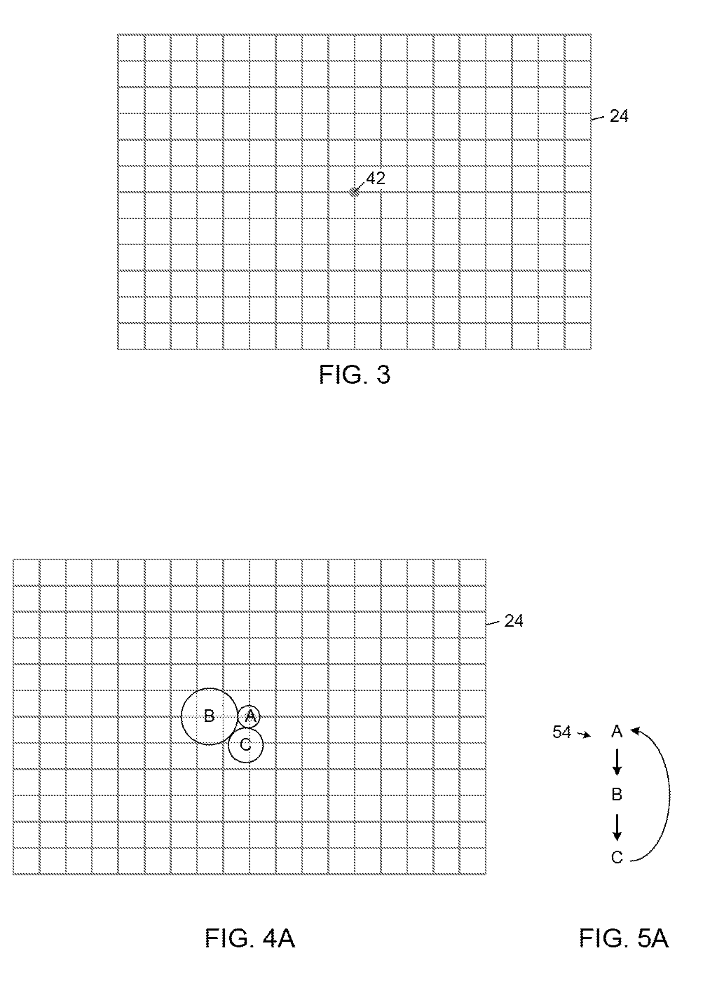

Initially, the layout generator module 16 arranges at least two circular graphic objects selected from the set 12 at respective locations in the coordinate plane 24 where the circular graphic objects are mutually tangent (FIG. 2, block 40). In the exemplary embodiment shown in FIG. 3, the coordinate plane 24 has a reference location 42 (or reference coordinate). In general, the reference location 42 can be positioned anywhere in the coordinate plane 24.

During the execution of the process of block 40, the layout generator module 16 sequentially processes the metadata 20 for the circular graphic objects 14. In some embodiments, the layout generator module 16 processes the metadata 20 in the order in which they are listed in an input file. In some implementations, the input file lists the metadata 20 in an arbitrary order. In other implementations, the input file lists the metadata 20 an order that is sorted in accordance with one or more of the metadata values. For example, in some embodiments, the metadata includes a respective size value for each of the graphic objects 14 and the metadata in the input file are listed in order of decreasing size.

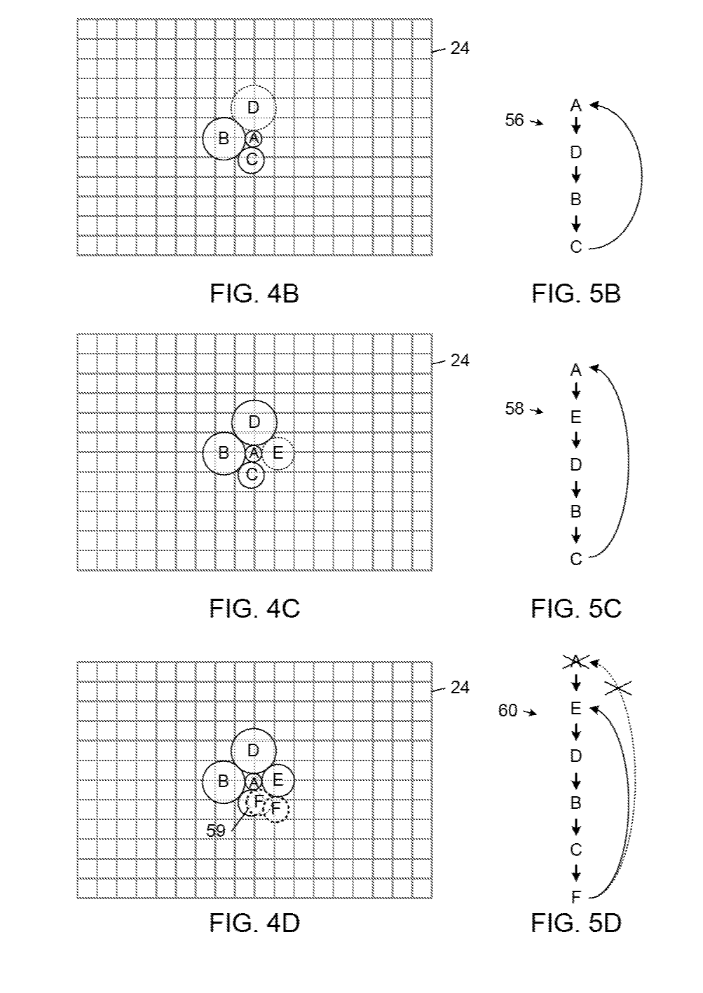

FIG. 4A shows an exemplary arrangement of three circular graphic objects A, B, C that are positioned in respective locations in the coordinate plane 24. In one exemplary process, the layout generator module 16 generates this arrangement by initially placing the circular graphic object A at a location centered on the reference location 42. The layout generator module 16 then positions the circular graphic object B at a location in the coordinate plane 24 where the circular graphic object B is tangent to the circular graphic object A. Next, the layout generator module 16 positions the circular graphic object C at a location in the coordinate plane 24 where the circular graphic object C is tangent to both the circular graphic objects A and B.

Referring back to FIG. 2, the layout generator module 16 chooses another one of the circular graphic objects from the set 12 as the current circular graphic object (FIG. 2, block 44). In this process, the layout generator module 16 loads the next circular-graphic-object-characterizing metadata 20 listed in the input file. In the illustrated embodiments, the layout generator module 16 chooses the circular graphic object D as the current circular graphic object because it follows the circular graphic object C in the set 12.

The layout generator module 16 selects a current target one of the circular graphic objects in the coordinate plane based on application of a selection metric to the distances respectively separating the circular graphic objects in the coordinate plane from the reference location 42 (FIG. 2, block 46). The layout generator module 16 typically executes the selecting process of block 46 by selecting as the current target circular graphic object a peripheral one of the circular graphic objects that is closest to the reference location 42 and with respect to which the current circular graphic object is tangentially positionable without intersecting any of the circular graphic objects currently positioned in the coordinate plane 24. In some embodiments, the layout generator module 16 determines the Euclidean distances respectively separating the reference location 64 from the centers of the peripheral ones of the circular graphic objects that already have been located in the coordinate plane. In general, the selection metric may correspond to any type of optimization process metric that may be applied to the determined distances. With respect to the illustrated embodiments, the selection metric corresponds to the minimum of the determined distances. In the example shown in FIG. 4B, circular graphic object A has the shortest separation distance (namely, zero distance) from the reference location 42 and therefore is selected as the current target circular graphic object.

The layout generator module 16 positions the current circular graphic object at a respective location in the coordinate plane 24 where the current circular graphic object is tangent to the current target circular graphic object and tangent to another one of the circular graphic objects in the coordinate plane (FIG. 2, block 48). In the example shown in FIG. 4B, the circular graphic object D is positioned at a location in the coordinate plane 24 where it is tangent to both the circular graphic object A and the circular graphic object B.

The layout generator module 16 repeats the choosing process (FIG. 2, block 44), the selecting process (FIG. 2, block 46), and the positioning process (FIG. 2, block 48) for each of the circular graphic objects remaining in the set 12 (FIG. 2, block 50). For example, in the iteration following the iteration shown in FIG. 4B, the layout generator module 16 chooses the circular graphic object E as the current circular graphic object, selects the circular graphic object A as the current target circular graphic object, and positions the circular graphic object E at a location in the coordinate plane 24 where it is tangent to both the current target circular graphic object A and the circular graphic object D, as shown in FIG. 4C.

If there are no more circular graphic objects left in the set 12 to position in the coordinate plane 24, the layout generator module 16 generates a specification of the locations of the circular graphic objects 14 in the coordinate plane 24 (FIG. 2, block 52).

In some embodiments, the layout generator module 16 maintains a boundary list of peripheral (or boundary) ones of the circular graphic objects with respect to which the current circular graphic object is tangentially positionable. In this process, the layout generator module 16 updates a linked list of the peripheral circular graphic objects after each current circular graphic object has been positioned in the coordinate plane 24. The boundary list includes for each of the peripheral circular objects a respective link pointing to another one of the peripheral circular graphic objects that is tangent to the peripheral circular object in the coordinate plane. The links are ordered in accordance with an ordering of the locations of the peripheral circular objects that defines a closed boundary path that surrounds all of the non-peripheral ones of the circular graphic objects. The links may be ordered in a clockwise direction or a counterclockwise direction.

In one example, the boundary list begins with the circular graphic object whose placement on the coordinate plane precedes other boundary graphic objects. For example, FIG. 5A shows a boundary list 54 that is generated after the circular graphic objects A, B, and C have been positioned in the coordinate plane 24. Each of the circular graphic objects A, B and C are peripheral circular graphic objects. FIG. 5B shows a boundary list 56 that is generated by updating the boundary list 54 to reflect the position of circular graphic object D in the coordinate plane 24 being tangent with peripheral circular graphic objects A and B. FIG. 5C shows a boundary list 58 that is generated by updating the boundary list 56 to reflect the position of circular graphic object E in the coordinate plane 24 in terms of its tangential relationship between boundary or peripheral objects A and D.

In the embodiments in which the boundary list is maintained, the layout generator module 16 selects the current target circular graphic object from the boundary list. The layout generator module 16 attempts to position the current circular graphic object at a location in the coordinate plane that is tangent to both the current target circular graphic object and the successive circular graphic object in the boundary list. In the process of positioning the current circular object in the coordinate plane 24 (FIG. 2, block 46), the layout generator module 16 determines whether, at its respective location, the current circular graphic object intersects another one of the circular graphic objects in the coordinate plane 24. If so, the layout generator module 16 removes from the boundary list either the current target circular graphic object or the successive circular graphic object in the boundary list with respect to which the current circular graphic object is tangent. If the circular graphic object that is intersected by the current circular graphic object is before the current target circular object in the boundary list, the current target circular object is removed from the boundary list; otherwise, the circular graphic object with respect to which the current circular graphic object is tangent is removed from the boundary list. The layout generator module 16 then repeats the selecting process (FIG. 2, block 46) and the positioning process (FIG. 2, block 48) for the as yet unpositioned current circular graphic object based on the updated boundary list.

As shown in FIG. 4D, for example, after selecting the circular graphic object F as the current circular graphic object, the layout generator module 16 initially selects from the boundary list 58 the circular graphic object A as the current target circular graphic object because it is the closest to the reference location 42. The layout generator module 16 then positions the circular graphic object F in the coordinate plane at a location 59 where it is tangent to the current target circular graphic object (i.e., circular graphic object A) and the successive circular graphic object (i.e., circular graphic object E which is tangent to object A) in the boundary list 58. At this location, however, the circular graphic object F intersects the circular graphic object C. Since the intersected circular graphic object C is before the current target circular graphic object A in the boundary list 58, the current target circular graphic object A is removed from the boundary list 58. The process then is repeated based on the updated boundary list. In this regard, the circular graphic object C is selected as the current target circular graphic object because its center is closer to the reference location than the centers of any of the other circular graphic objects in the boundary list. The current circular graphic object F is positioned in the coordinate plane at a location where it is tangent to the current target circular graphic object C and the successive object (i.e., E) in the updated boundary list. The circular graphic object F also is added to the updated boundary list between the circular objects C and E to create the updated boundary list 60 shown in FIG. 5D.

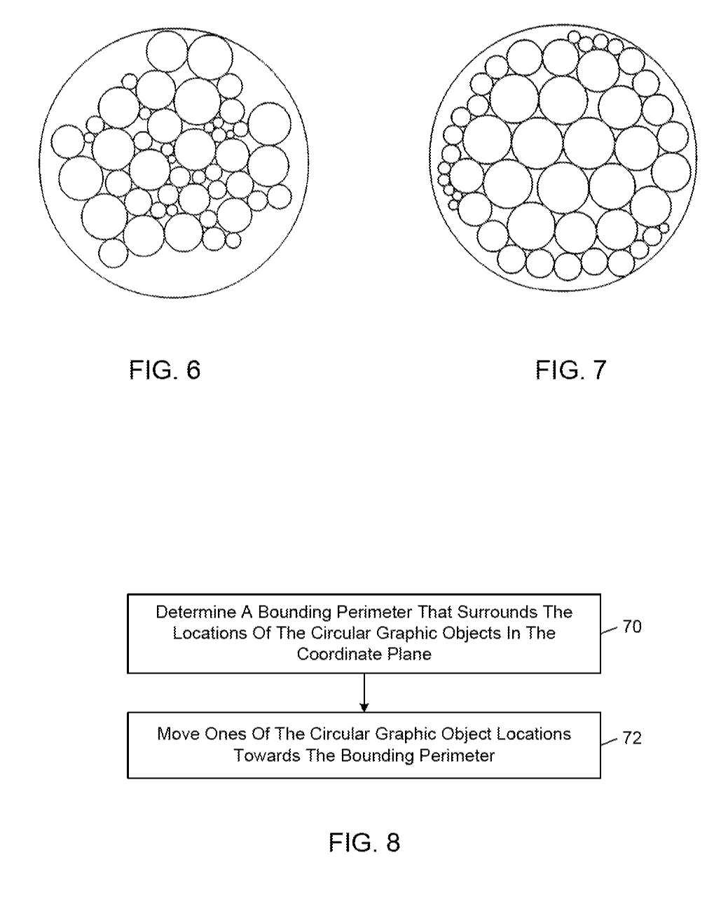

FIG. 6 shows an exemplary layout of circular graphic objects generated by an embodiment of the layout generator module 16 in accordance with the method of FIG. 2 from an unsorted list of circular graphic object size metadata.

FIG. 7 shows an exemplary layout of circular graphic objects generated by an embodiment of the layout generator module 16 in accordance with the method of FIG. 2 from a list of circular graphic object size metadata that are sorted from largest size to smallest size. A comparison of the layouts shown in FIGS. 6 and 7 reveals that sorting the list of metadata in order of decreasing size increases the degree to which the layout approximates a close-packed layout of circular graphic objects.

C. Modifying a Space-Filling Layout of Circular Graphic Objects

FIG. 8 shows an embodiment of a method by which the layout generator module 16 modifies the space-filling layout of circular graphic objects that is generated in accordance with the method of FIG. 2.

In accordance with this embodiment, the layout generator module 16 determines a bounding perimeter that surrounds the locations of the circular graphic objects in the coordinate plane (FIG. 8, block 70). In general, the bounding perimeter may correspond to any type of plane closed figure including, but not limited to a polygonal shape (e.g., a triangle, a square, a quadrilateral, etc.), a curved shape (e.g., a circle, an ellipse, a polygon with rounded vertices, etc.), or any other shape (e.g., a cloud shape).

In accordance with some embodiments of the process of block 70, the layout generator module 16 initially determines the smallest circular bounding perimeter that is centered on the reference location in the coordinate plane and encircles all of the circular graphic objects in the layout. The layout generator module 16 then transforms (e.g., by translating and scaling) the initial circular bounding perimeter 76 into the smallest circular bounding perimeter that surrounds all of the circular graphic objects in the layout.

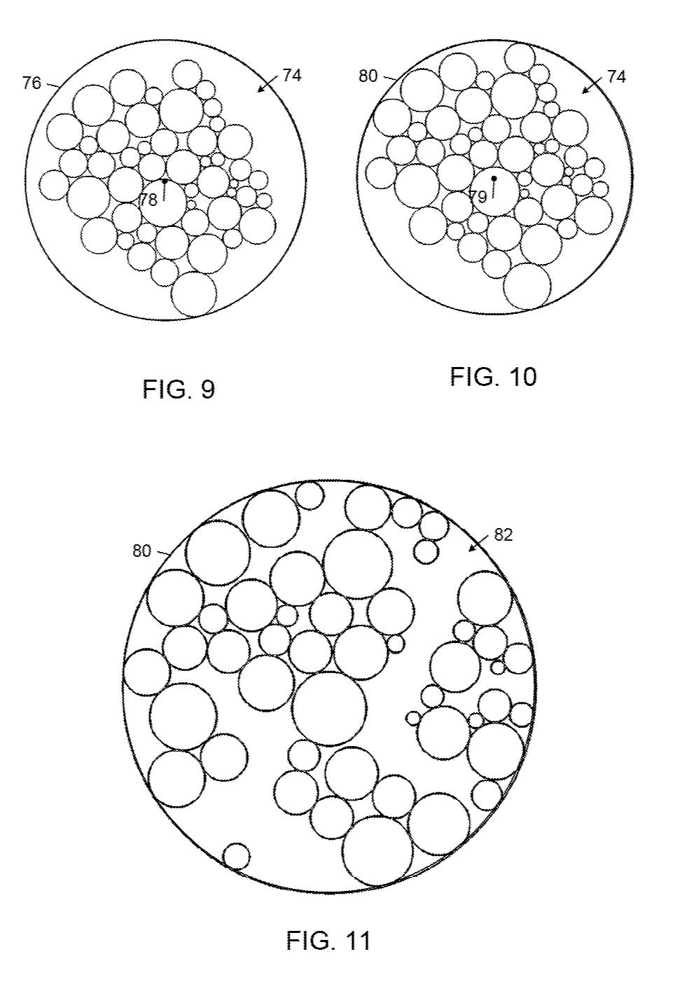

FIG. 9, for example, shows an exemplary layout 74 of circular graphic objects that is generated by an embodiment of the layout generator module 16 in accordance with the method of FIG. 2 from an unsorted list of circular graphic object size metadata. FIG. 9 also shows an initial circular bounding perimeter 76 that is centered at a reference location 78, which was used in the creation of the layout 74. FIG. 10 shows a final circular bounding perimeter 80 that is determined by translating the initial circular bounding perimeter 76 downward and to the right to a new center location 79, and reducing the radial dimension of the initial circular bounding perimeter 76 to the smallest size that encompasses all of the circular graphic objects in the layout 74.

After the bounding perimeter has been determined (FIG. 8, block 70), the layout generator module 16 moves ones of the circular graphic object locations towards the bounding perimeter (FIG. 8, block 72). In some embodiments in which the bounding perimeter defines a bounding circle, the layout generator module 16 moves one or more of the circular graphic object locations along respective radii of the bounding circle toward the circular bounding perimeter. In other embodiments, the layout generator module 16 moves one or more of the circular graphic object locations along respective pseudorandom paths towards the circular bounding perimeter. In the process of moving the one or more circular graphic objects, the layout generator module 16 typically ensures that none of the circular graphic object locations is moved to a location that intersects any of the other circular graphic objects in the coordinate plane. The layout generator module 16 also typically ensures that none of the circular graphic object locations is moved to a location that intersects the bounding perimeter. In some embodiments, the layout generator module 16 incrementally moves ones of the circular graphic object locations and terminates the incremental movement of the circular graphic objects with a specified probability.

In some embodiments, the layout generator module 16 moves one or more of the circular graphic objects in the space-filling layout in accordance with the following process:
1. Determine a smallest bounding circle that encircles all of the circular graphic objects in the boundary list.
2. Sequentially process the circular graphic objects in an order that is the reverse of the order in which they were placed on the coordinate plane in generating the space-filling layout.
3. Select the next current circular graphic object from the reverse-ordered list.
4. Move the current circular graphic object along a radius of the bounding circle toward the circular bounding perimeter in accordance with the following rules:
   a. move the current circular graphic object along the corresponding radius of the bounding circle toward the circular bounding perimeter by one coordinate location (e.g., one pixel location);
   b. if the current circular graphic object intersects the circular bounding perimeter or any other circular graphic object, go to step 4d;
   c. with a probability of r (where r typically is a number close to 1, e.g., 0.999) go back to step 4a;
   d. move the current circular graphic object back along the corresponding radius of the bounding circle toward the center of the bounding circle by one coordinate location (e.g., one pixel location).
5. If there are any more circular graphic objects to process, go to step 3
6. End

FIG. 11 shows an exemplary layout 82 of circular graphic objects that is generated by an embodiment of the layout generator module 16 in accordance with the preceding space-filling-layout-modification process described. As shown in FIG. 11, this modification process produces a visually appealing layout of the circular graphic objects that has a bubble-like appearance.

### III. Circular Graphic Object Based Visualization of Clustered Data

The circular graphic object visualization systems and methods described above may be applied to any type of graphic objects that may be displayed or rendered with circular shapes. In some embodiments, these systems and method are used to visualize clustered data objects.

A. Clustering Data Objects

Clustering is the process of partitioning data objects into clusters, where the members of each cluster are selected based on one or more shared characteristics. Automated clustering typically is performed by a classifier that partitions the data objects based on one or more rules (or predicates), which define cluster classes in terms of at least one condition on metadata that is associated with the data objects. As used herein, the term “predicate” refers to an operator or a function that returns a Boolean value (e.g., true or false). A “metadata predicate” is an operator or a function that returns a Boolean value based on the values of one or more metadata.

In general, the data objects may correspond to any type of data that is associated with one or more types of metadata. In some exemplary embodiments, the data objects correspond to image objects. An image object typically is in the form of a digital image file that includes image data and associated metadata. The metadata may be embedded in a header (e.g., an EXIF header) of the digital image file or otherwise linked to the digital image file (e.g., stored in a separate data structure that is linked to the digital image file). In general, the metadata may have been recorded during the capture of the corresponding image data, later derived from such metadata or from an analysis of the image data, or specified by a user. Exemplary types of metadata that may be associated with the image file include collateral metadata and content-based metadata that is extracted automatically from the image data. Among the exemplary types of collateral metadata are capture date, capture time, shutter speed, aperture size, lens focal length, flash operation information, white balance information, automatic gain setting information, resolution/image size, degree of compression, file format (e.g., JPEG vs. GIF vs. TIFF vs. RAW formats), shooting mode (e.g., aperture-priority vs. shutter-priority vs. manual control), light metering mode (e.g., center spot vs. weighted vs. evaluative), and special effects (e.g., black & white vs. vivid vs. neutral vs. sepia). Among the exemplary types of metadata that can be derived from the corresponding image data are maximum, minimum, and/or average intensities of the pixels recorded in the image, intensity histogram information, whether the image is overexposed or underexposed, whether the image was taken under natural or artificial lighting (e.g., via estimation of color balance), reduced-resolution or “thumbnail” versions of the image data 18, keyframes, and face recognition information.

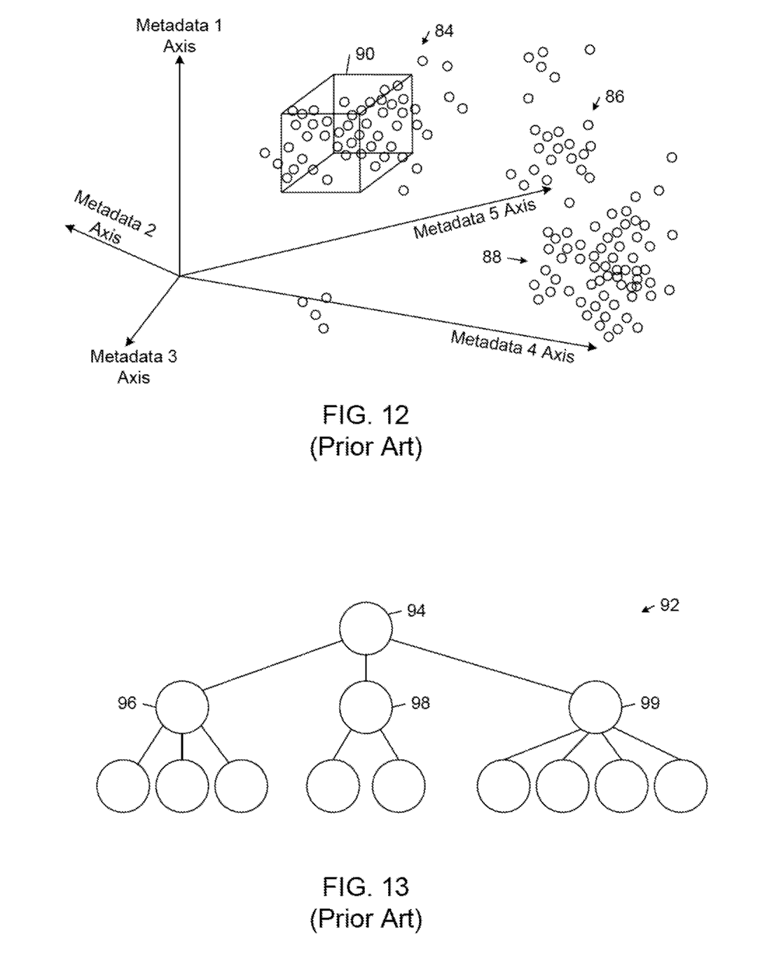

FIG. 12 shows an exemplary mapping of data objects (represented by circles) into a devised metadata space that is defined along five dimensions corresponding to five different types of metadata (i.e., Metadata 1, Metadata 2, . . . , Metadata 5). In this derived mapping, the data objects form three clusters 84, 86, 88 in the devised metadata space. These clusters may be identified using standard data mining techniques (e.g., k nearest neighbor (k-NN) clustering, hierarchical agglomerative clustering, and k-means clustering). In some implementations, relational data mining techniques, such as learning of relational decision trees, relational classification and association rules, and distance based approaches to relational learning and clustering, are used to identify patterns corresponding to the boundaries of regions (e.g., the rectangular box-shaped region 90) that respectively encompass the identified data objects. The identified boundaries can be translated into metadata predicates, which can be used by the classifier to classify data objects into respective cluster classes.

After the data objects have been partitioned into clusters, the hierarchical structure of the clusters may be represented by a tree structure. FIG. 13 shows an exemplary tree structure 92 that includes a root node 94, which has three offspring 96, 98, 99, which in turn have respective sets of offspring.

B. Visualizing Face Clusters

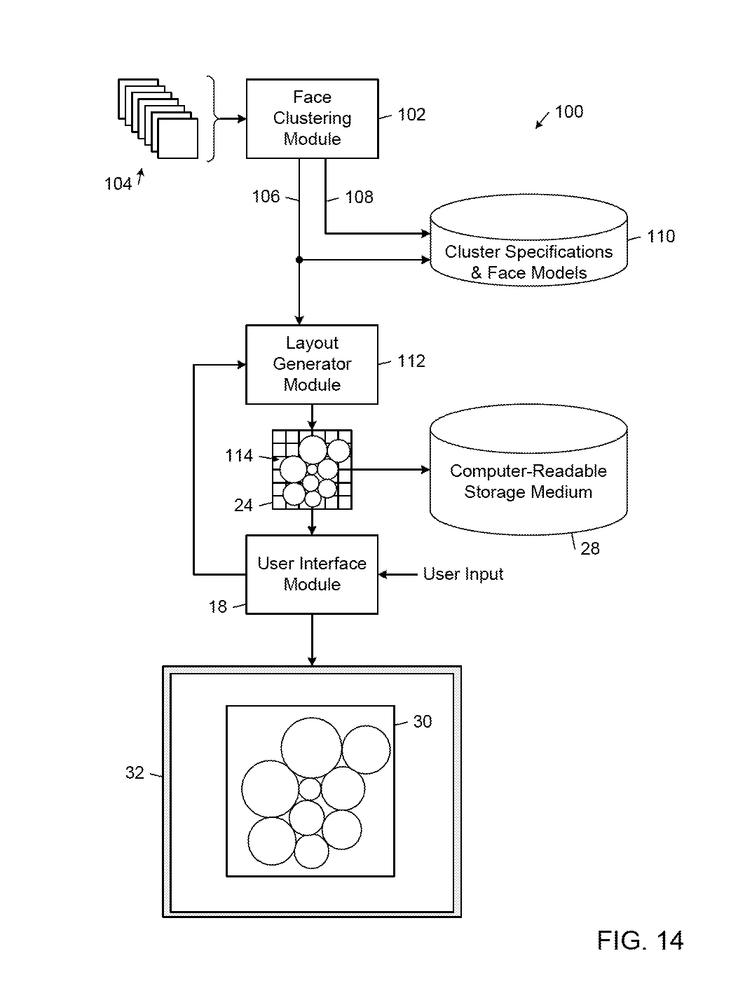

FIG. 14 shows an embodiment 100 of the visualization system 10 that additionally includes a face clustering module 102. The face clustering module 102 processes a collection of input images 104 to generate cluster specifications 106 and cluster face models 108, which are stored in a database 110 in association with the input images 104.

Each of the input images 104 may correspond to any type of image, including an original image (e.g., a video keyframe, a still image, or a scanned image) that was captured by an image sensor (e.g., a digital video camera, a digital still image camera, or an optical scanner) or a processed (e.g., sub-sampled, cropped, rotated, filtered, reformatted, enhanced or otherwise modified) version of such an original image.

Each cluster specification 106 corresponds to a different respective face that is detected in the associated input image 104. In some embodiments, each duster specification 106 includes a description of the locations (e.g., universal resource locators (URLs)) of the associated ones of input images 104 containing the constituent faces, along with the locations of the constituent faces (e.g., the coordinates of the bounding boxes containing the face regions) within each of these input images. In some embodiments, the face clustering module 102 stores the cluster specifications 106 in respective data structures (e.g., tables or lists) that are linked to the associated ones of the input images 104. In some embodiments, each input image 104 is associated with a respective cluster specification 106 for each face that is detected in the input image 104. Thus, in these embodiments, input images 104 that contain multiple detected faces are associated with multiple cluster specifications 106. In some embodiments, each cluster specification 106 additionally includes a designation of one of the faces appearing in one of the constituent images as a face image that is representative of the cluster.

Additional details regarding the construction and operation of the face clustering module 102 can be obtained from U.S. patent application Ser. No. 11/545,898, filed Oct. 6, 2006, and Gu, L., Zhang, T. and Ding, X, “Clustering Consumer Photos Based on Face Recognition,” Proc. ICME07, IEEE (2007), pp. 1998-2001, both of which are incorporated herein by reference.

In some embodiments, the layout generator module 112 receives the cluster specifications 106 from the face clustering module 102. For each of the clusters, the layout generator module 112 clips a circular portion of the image containing the representative face image. The circular face image is clipped using a respective mask that is generated based on the location of the representative face that is specified in the cluster specification 106. The layout generator module 112 scales the clipped face images in size in accordance with the numbers of images in the respective clusters. In some embodiments, the areas of the scaled images are proportional to the square of the number of images in the respective clusters. The layout generator module 112 determines a layout 114 of the scaled face images in the coordinate plane 24 in accordance with one or more of the methods described above.

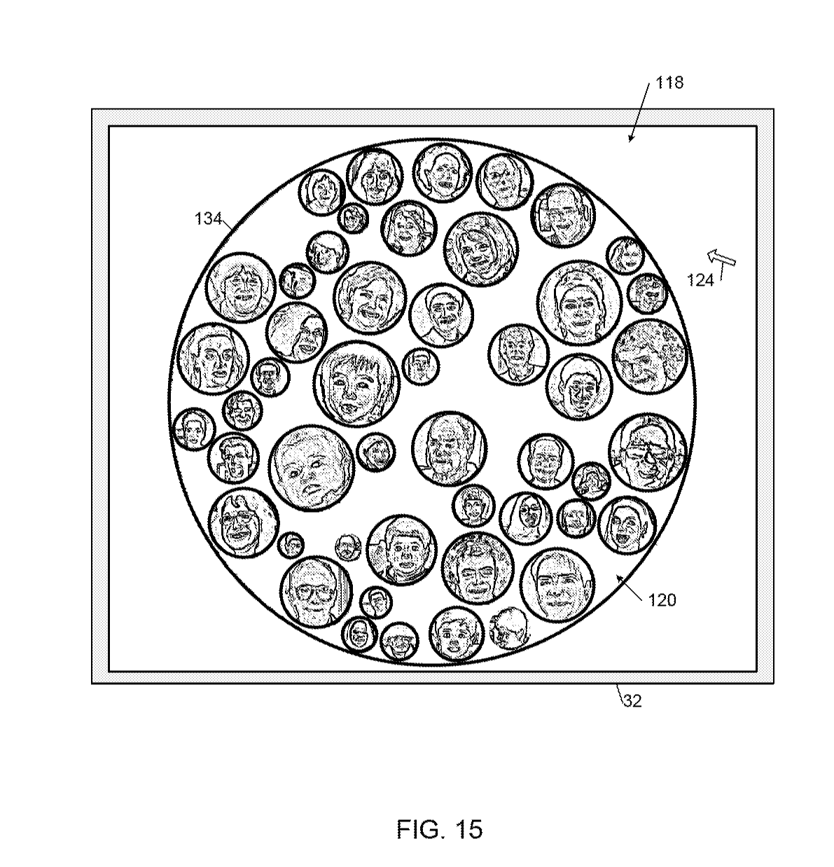

FIG. 15 shows the display 32 presenting a graphical user interface 118 that contains a layout 120 of circular face images representing respective ones of the face clusters that were identified by the face clustering module 102. The layout 120 is generated in accordance with embodiments of the methods of FIGS. 2 and 8. The circular face images are contained within a circular bounding perimeter 122, which enhances the bubble-like appearance of the face images. In some embodiments, the bubble-like effect is further enhanced by dynamically presenting the circular face images from an initial state in which they have zero radii and zero opacity to a final state in which they have their final radii and 100% opacity using randomized delay and speed. A user may select one or more of the circular face images using, e.g., a pointer 124 that is controlled by one or more input devices (e.g., a computer mouse, a keyboard, or a touchpad).

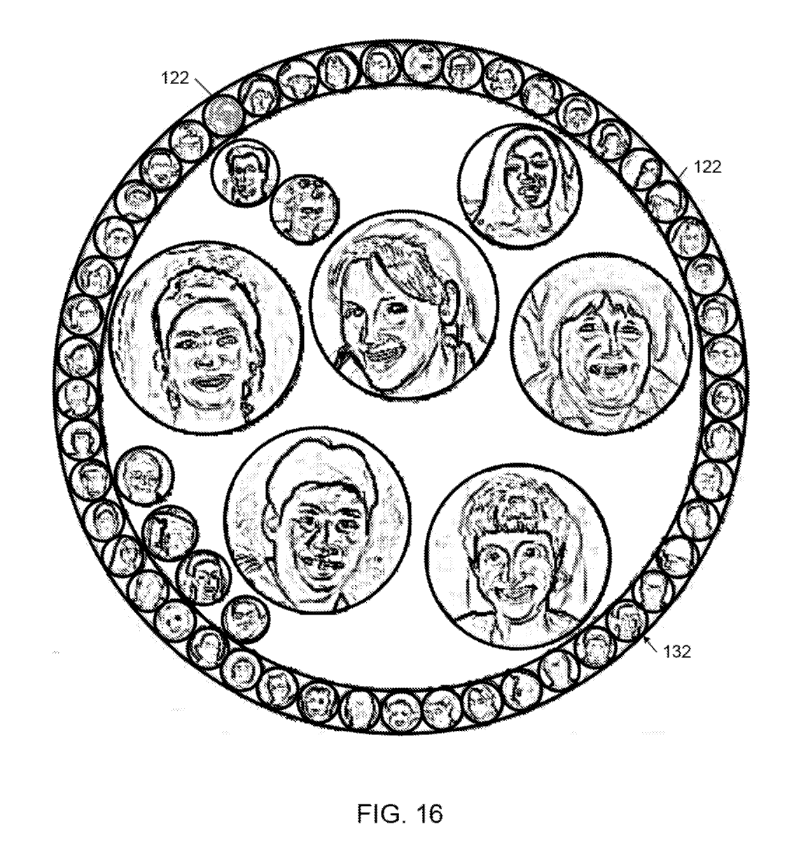

In some embodiments, in addition to the one-glance view of the face images shown in FIG. 15, users can further explore the clusters that are represented by the faces images. For example, these embodiments allow users to focus or zoom-in on a particular representative face image 128 (see FIG. 16). In response to user selection of one of the circular face images presented in the graphical user interface 118, the user interface module 18 (FIG. 14) moves the circular face images to respective non-overlapping adjacent locations along the circular bounding perimeter 122 and scales the circular face images to form a ring 132 of face images, as shown in FIG. 16. In some embodiments, the location of the selected face image 134 in the ring 132 is highlighted. Within the area bounded by the ring 132, the user interface module 18 presents circular face images that have been extracted from images in the cluster that is represented by the selected face image (i.e., the images in the collection that have been determined to contain the human face contained in the selected face image). In some embodiments, the user interface module 18 scales the circular face images within the ring 132 in size based on the respective frequencies with which the human faces appear in the images together with the human face contained in the selected face image (i.e., the co-occurrence frequencies of the faces). Users can directly click on the circular face images in the ring 132 to inspect other face clusters.

### IV. Exemplary Architectures of the Circular Graphic Object Visualization System

Embodiments of the visualization system 10 (including the embodiment 100) may be implemented by one or more discrete modules (or data processing components) that are not limited to any particular hardware, firmware, or software configuration. In the illustrated embodiments, the modules may be implemented in any computing or data processing environment, including in digital electronic circuitry (e.g., an application-specific integrated circuit, such as a digital signal processor (DSP)) or in computer hardware, firmware, device driver, or software. In some embodiments, the functionalities of the modules are combined into a single data processing component. In some embodiments, the respective functionalities of each of one or more of the modules are performed by a respective set of multiple data processing components.

In some implementations, process instructions (e.g., machine-readable code, such as computer software) for implementing the methods that are executed by the embodiments of the visualization system 10, as well as the data it generates, are stored in one or more machine-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

In general, embodiments of the visualization system 10 may be implemented in any one of a wide variety of electronic devices, including desktop and workstation computers, video recording devices (e.g., VCRs and DVRs), cable or satellite set-top boxes capable of decoding and playing paid video programming, and digital camera devices. Due to its efficient use of processing and memory resources, some embodiments of the visualization system 10 may be implemented with relatively small and inexpensive components that have modest processing power and modest memory capacity. As a result, these embodiments are highly suitable for incorporation in compact camera environments that have significant size, processing, and memory constraints, including but not limited to handheld electronic devices (e.g., a mobile telephone, a cordless telephone, a portable memory device such as a smart card, a personal digital assistant (PDA), a solid state digital audio player, a CD player, an MCD player, a game controller, a pager, and a miniature still image or video camera), pc cameras, and other embedded environments.

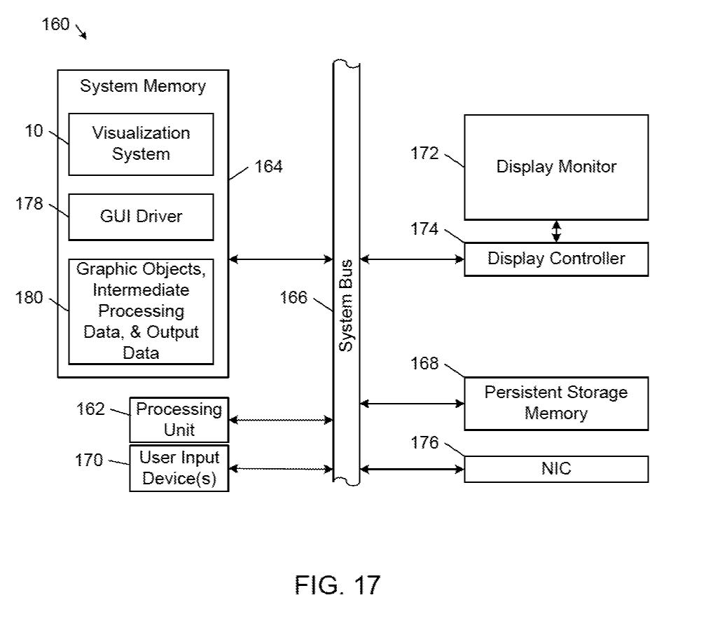

FIG. 17 shows an embodiment of a computer system 160 that incorporates the visualization system 10. The computer system 160 includes a processing unit 162 (CPU), a system memory 164, and a system bus 166 that couples processing unit 162 to the various components of the computer system 160. The processing unit 162 typically includes one or more data processors, each of which may be in the form of any one of various commercially available processors. The system memory 164 typically includes a read only memory (ROM) that stores a basic input/output system (BIOS) that contains start-up routines for the computer system 160 and a random access memory (RAM). The system bus 166 may be a memory bus, a peripheral bus or a local bus, and may be compatible with any of a variety of bus protocols, including PCI, VESA, Microchannel, ISA, and EISA. The computer system 160 also includes a persistent storage memory 168 (e.g., a hard drive, a floppy drive, a CD ROM drive, magnetic tape drives, flash memory devices, and digital video disks) that is connected to the system bus 166 and contains one or more computer-readable media disks that provide non-volatile or persistent storage for data, data structures and computer-executable instructions.

A user may interact (e.g., enter commands or data) with the computer 160 using one or more input devices 170 (e.g., a keyboard, a computer mouse, a microphone, joystick, and touch pad). Information may be presented through a graphical user interface (GUI) that is displayed to the user on a display monitor 172, which is controlled by a display controller 174. The computer system 160 also typically includes peripheral output devices, such as speakers and a printer. One or more remote computers may be connected to the computer system 160 through a network interface card (NIC) 176.

As shown in FIG. 17, the system memory 164 also stores the visualization system 160, a GUI driver 178, graphic object files corresponding to the circular graphic objects 14, intermediate processing data, and output data. In some embodiments, the visualization system 10 interfaces with the GUI driver 178 and the user input 170 to control the creation of the layouts of circular graphic objects on a page. In some embodiments, the computer system 160 additionally includes a graphics application program that is configured to render image data on the display monitor 172 and to perform various image processing operations on the circular graphic object layouts and on the graphic objects themselves.

### V. Conclusion

The embodiments that are described in detail herein provide ways to arrange circular graphic objects on a page. These embodiments not only provide visually appealing results that make efficient use of the available display area, but also achieve these results quickly and efficiently. Some embodiments additionally provide ways to utilize these arrangements of circular graphic objects in visualizing clustered data.

Other embodiments are within the scope of the claims.

What is claimed is:

1. A method, comprising:
arranging at least two circular graphic objects selected from a set of circular graphic objects at respective locations in a coordinate plane where the circular graphic objects are mutually tangent, wherein the coordinate plane has a reference location;
choosing another one of the circular graphic objects from the set as a current circular graphic object;
selecting a current target one of the circular graphic objects in the coordinate plane based on application of a selection metric to distances respectively separating the circular graphic objects in the coordinate plane from the reference location;
positioning the current circular graphic object at a respective location in the coordinate plane where the current circular graphic object is tangent to the current target circular graphic object and tangent to another one of the circular graphic objects in the coordinate plane;
repeating the choosing, the selecting, and the positioning; and
generating a specification of the locations of the circular graphic objects in the coordinate plane.

2. The method of claim 1, wherein the arranging comprises arranging the at least two circular graphic objects in an area of the coordinate plane that includes the reference location, and the selecting comprises selecting as the current target circular graphic object a peripheral one of the circular graphic objects that is closest to the reference location and with respect to which the current circular graphic object is tangentially positionable.

3. The method of claim 1, further comprising maintaining a boundary list of peripheral ones of the circular graphic objects with respect to which the current circular graphic object is tangentially positionable.

4. The method of claim 3, wherein the maintaining comprises updating a linked list of the peripheral circular graphic objects after each current circular graphic object has been positioned in the coordinate plane, and the selecting comprises choosing the current target circular graphic object from the boundary list.

5. The method of claim 4, wherein:
the boundary list comprises for each of the peripheral circular objects a respective link pointing to another one of the peripheral circular graphic objects that is tangent to the peripheral circular object in the coordinate plane, the links being ordered in accordance with an ordering of the locations of the peripheral circular objects that defines a closed boundary path; and
in response to a determination that at its respective location the current circular graphic object intersects one of the circular graphic objects in the coordinate plane, the positioning comprises
removing the current target circular graphic object from the boundary list if it is immediately preceded by the intersected circular graphic object in the boundary list,
removing the peripheral circular graphic object linked to the current target graphic object if it is immediately followed by the intersected circular graphic object in the boundary list, and
repeating the selecting and the positioning for the current circular graphic object.

6. The method of claim 1, further comprising determining a bounding perimeter that surrounds the locations of the circular graphic objects in the coordinate plane and moving ones of the circular graphic object locations towards the bounding perimeter.

7. The method of claim 6, wherein the bounding perimeter defines a bounding circle, and the moving comprises moving ones of the circular graphic object locations along respective radii of the bounding circle.

8. The method of claim 6, wherein the moving comprises moving ones of the circular graphic object locations along respective pseudorandom paths towards the bounding perimeter.

9. The method of claim 6, wherein the moving comprises ensuring that none of the circular graphic object locations is moved to a location that intersects any of the other circular graphic objects in the coordinate plane.

10. The method of claim 6, wherein the moving comprises ensuring that none of the circular graphic object locations is moved to a location that intersects the bounding perimeter.

11. The method of claim 6, wherein the moving comprises incrementally moving ones of the circular graphic object locations and terminating the incremental moving with a specified probability.

12. The method of claim 1, further comprising scaling each of the circular graphic objects in size based on a respective number of the graphic objects determined to be related to circular graphic object.

13. The method of claim 1, wherein each of the circular graphic objects is a circular image of a respective face.

14. The method of claim 13, wherein each of the circular graphic objects is representative of a respective cluster of images, and further comprising scaling the ones of the circular graphic objects in size based on respective numbers of the images in the respective clusters, wherein the arranging, the choosing, the selecting, and the positioning are performed based on the scaled sizes of the circular graphic objects.

15. The method of claim 1, further comprising presenting the circular graphic objects on a display at locations determined from the specification and, in response to user selection of one of the presented circular graphic objects, translating the circular graphic objects to respective non-overlapping adjacent locations along a circular perimeter and scaling the circular graphic objects to form a ring.

16. The method of claim 15, further comprising presenting within the ring circular objects determined to be related to the selected circular graphic object.

17. The method of claim 16, further comprising scaling sizes of the circular objects presented within the ring based on respective degrees to which the circular objects presented within the ring are related to the selected circular graphic object.

18. The method of claim 17, wherein the scaling comprises scaling the sizes of the circular objects presented within the ring based on respective frequencies with which content in the circular objects presented within the ring appear together with content in the selected circular graphic object.

19. Apparatus, comprising:
a memory; and
a processing unit coupled to the memory and operable to perform operations comprising
arranging at least two circular graphic objects selected from a set of circular graphic objects at respective locations in a coordinate plane where the circular graphic objects are mutually tangent, wherein the coordinate plane has a reference location;
choosing another one of the circular graphic objects from the set as a current circular graphic object;
selecting a current target one of the circular graphic objects in the coordinate plane based on application of a selection metric to distances respectively separating the circular graphic objects in the coordinate plane from the reference location;
positioning the current circular graphic object at a respective location in the coordinate plane where the current circular graphic object is tangent to the current target circular graphic object and tangent to another one of the circular graphic objects in the coordinate plane;
repeating the choosing, the selecting, and the positioning; and
store in the memory a specification of the locations of the circular graphic objects in the coordinate plane.

20. A machine readable medium for arranging graphic objects on a page, the machine readable medium storing machine-readable instructions causing a machine to perform operations comprising:
arranging at least two circular graphic objects selected from a set of circular graphic objects at respective locations in a coordinate plane where the circular graphic objects are mutually tangent, wherein the coordinate plane has a reference location;
choosing another one of the circular graphic objects from the set as a current circular graphic object;
selecting a current target one of the circular graphic objects in the coordinate plane based on application of a selection metric to distances respectively separating the circular graphic objects in the coordinate plane from the reference location;
positioning the current circular graphic object at a respective location in the coordinate plane where the current circular graphic object is tangent to the current target circular graphic object and tangent to another one of the circular graphic objects in the coordinate plane;
repeating the choosing, the selecting, and the positioning; and
generating a specification of the locations of the circular graphic objects in the coordinate plane.
